(19) United States
(12) Patent Application Publication
(10) Pub. No.: US 2009/0038081 A1
(43) Pub. Date: Feb. 12, 2009

(54) JACK, WINCH, AND TIRE RETRIEVAL TOOLS

(75) Inventors: Roy A. Berton, Bolton (CA); Dragos N. Neculau, Toronto (CA)

Correspondence Address: PILLSBURY WINTHROP SHAW PITTMAN, LLP, P.O. BOX 10500, MCLEAN, VA, 22102, US

(73) Assignee: Ventra Group, Inc., Bradford (CA)

(21) Appl. No.: 11/834,388

(22) Filed: Aug. 6, 2007

(51) Int. Cl. B25F 1/00

(52) U.S. Cl. 7/100

(57) ABSTRACT

A tool kit is provided to be stored in a vehicle to enable an operator in emergency situations to effect minor repairs, for example, to change a flat tire. The tool kit includes: a lug wrench, an extension, and a hook driver. The tools are used together to form three configurations. The first configuration being configured to activate a winch mechanism to raise and lower a tire mounted underneath a vehicle. The second configuration being configured to activate a portable jack. The third configuration being configured to grasp and retrieve the lowered spare tire.

### FIELD

The present invention relates to a tool kit comprising inter-engaging tools including: a lug wrench, an extension, and a hook driver.

### BACKGROUND

In the vehicle industry it is common to provide various tools to be stored in a vehicle to enable an operator in emergency situations to effect minor repairs, for example, to change a flat tire of the vehicle.

A portable jack is usually provided to lift the vehicle, in order to provide sufficient clearance to remove the tire from the vehicle. A hook driver may also be provided, which may include a hooked end that connects to the jack. This advantageously allows the operator a greater degree of movement to rotate the driver in order to turn the drive gears and/or screw in the jack. Further, a handle may be provided which connects to the end of the driver, opposite the hooked end, to provide the operator greater mechanical advantage.

Before the tire may be removed from the vehicle the wheel nuts or “lug nuts” holding the wheel on the vehicle must be removed. Typically, a lug wrench is used to remove the lug nuts from the wheel of a vehicle. The lug wrench includes a socket configured and adapted to specifically engage the head of the lug nuts.

In some motor vehicles, for example pickup tracks, the spare tire is positioned in a transport position on the underside of the vehicle frame by means of a winch, which is attached to the frame. For example, U.S. Pat. Nos. 6,220,574; 5,878,627; and 5,060,912, herein incorporated by reference, disclose winch systems for holding a spare tire underneath a vehicle frame.

To store the spare tire, it is first attached to a lift plate, which, in turn, is attached to a free end of a hoist cable. The cable is attached, at its opposite end, to the winch. In the transport position, the hoist cable is wound within the winch, such that the spare tire is in a raised position secured to the underside of the vehicle.

In emergency situations, to change a tire of the vehicle, the winch is unwound lowering the spare tire to the ground, so that the operator may retrieve it. A crank member may be provided to operate the winch.

Unfortunately, when the spare tire is lowered to the ground beneath the vehicle, the spare tire may be located considerably outside the grasping reach of the operator, or the operator may have to get in an awkward position on the ground to fully extend his/her arm for reaching the lowered spare tire. Therefore, a grasping tool may be provided to capture and retrieve the lowered spare tire.

Thus, in a vehicle, there may be a number of tools required to be stored to perform various operations in emergency situations to effect minor repairs, for example, to change a flat tire on the vehicle. As discussed above, these operations may include:

1.) Activating the winch mechanism that holds the spare tire;

2.) Activating the jack to raise and lower the vehicle;

3.) Grasping and retrieving the spare tire from underneath the vehicle; and

4.) Removing/installing lug nuts to the wheels.

The inventors have endeavored to reduce the number of tools for these operations. Fewer tools requires less space in the vehicle for storage and minimizes the gross weight of the vehicle. Also, fewer tools lowers the overall manufacturing costs of the vehicle.

### SUMMARY

In a first embodiment of the invention, a tool kit to be stored in a vehicle for spare tire retrieval/mounting and operation of a jack for raising and lowering the vehicle, the vehicle comprising a body supported on wheels and a winch mechanism mounted beneath the body and supporting the spare tire in a raised position, is provided, comprising:

a lug wrench including a generally elongated body bent at an angle, a first end having a socket, a second end, and at least one opening provided through the body between the second end and the bend;

an extension including a generally elongated body, a first end adapted to be coupled in driving engagement to the drive input of the winch mechanism, and a second end; and

a hook driver including a generally elongated body, a first end having a hook adapted to be coupled in driving engagement to a drive input of the jack, end and a second end, wherein the hook joins to the body at the first end by a connecting portion;

wherein the connecting portion of the hook driver is configured to be coupled in a driving engagement to the at least one opening of the lug wrench, and the second end of the hook driver is configured to be coupled in driving engagement to the second end of the extension to establish a first configuration adapted to activate the winch mechanism for raising and lowering the spare tire from the vehicle frame by coupling the first end of the extension in driving engagement to the drive input of the winch mechanism and turning the lug wrench;

wherein the second end of the hook driver is configured to be coupled in driving engagement to the at least one opening of the lug wrench to establish a second configuration adapted to activate a vehicle jack by coupling the hook of the hook driver in driving engagement to the drive input of the jack and turning the lug wrench;

wherein the second end of the hook driver is configured to be coupled in an axial secure engagement to the second end of the extension to establish a third configuration adapted to grasp and retrieve the spare tire from beneath the vehicle by engaging the hook with the spare tire.

In a second embodiment of the invention, a method for using tooling for spare tire retrieval/mounting, and operation of a jack for raising and lowering the vehicle, the vehicle comprising a body supported on wheels and a winch mechanism mounted beneath the body and supporting the spare tire in a raised position, comprising:

providing the tool kit of the first embodiment; and

performing in any order:

using the extension, coupled with the hook driver, and further coupled with the lug wrench in the first configuration to rotate the drive input of the winch mechanism to raise and lower the spare tire from beneath the vehicle;

using the hook driver coupled with the lug wrench in the second configuration to rotate the drive input of the jack for raising and lowering the vehicle to allow for mounting of the spare tire; and

using the hook driver coupled with the extension in the third configuration to grasp and retrieve the spare tire lowered from the winch mechanism.

Other objects, features, and advantages of one or more embodiments of the present invention will seem apparent from the following detailed description, and accompanying drawings, and the appended claims.

### BRIEF DESCRIPTION OF THE DRAWINGS

Embodiments of the present invention will now be disclosed, by way of example only, with reference to the accompanying schematic drawings in which corresponding reference symbols indicate corresponding parts, in which

FIG. 1 shows a kit of interconnecting tools to be stored in a vehicle to enable an operator in emergency situations to effect minor repairs, in accordance with an embodiment of the present invention;

FIG. 2 shows a first configuration of the tools of FIG. 1, in accordance with an embodiment of the present invention;

FIG. 3 shows a second configuration of the tools of FIG. 1, in accordance with an embodiment of the present invention;

FIG. 4 shows a third configuration of the tools of FIG. 1, in accordance with an embodiment of the present invention;

FIG. 5 shows the first configuration of tools shown in FIG. 2, used to actuate a spare tire storage winch mechanism, in accordance with an embodiment of the present invention;

FIG. 6 shows the second configuration of the tools shown in FIG. 3, used to actuate a portable jack, in accordance with an embodiment of the present invention; and

FIG. 7 shows the third configuration of tools shown in FIG. 4, used to retrieve a spare tire, in accordance with an embodiment of the present invention.

### DETAILED DESCRIPTION

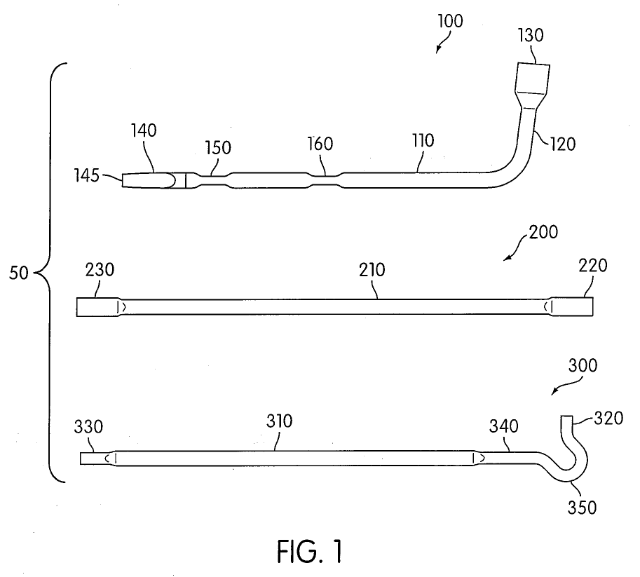

FIG. 1 shows a tool kit 50 to be stored in a vehicle to enable an operator in emergency situations to effect minor repairs, for example, to change a damaged (i.e., flat or worn) tire on the vehicle. The tool kit 50 preferably comprises: a lug wrench 100, an extension 200, and a hook driver 300. Using these three tools in different configurations all four of the operations mentioned above can be advantageously performed.

The lug wrench 100 includes a generally elongated body 110, a first end 120, and a second end 140. The body 110 is bent at an angle, such that the first end 120 is preferably in a bent relationship, forming approximately a right angle (90°) with respect to the remainder of the body 110. The first end 120 includes a socket 130 configured and adapted for engaging lug nuts. The distal portion of the second end 140 may be provided with a blade member 145, for example, a regular screwdriver blade, which may be used to remove hubcaps. The generally elongated body 110 includes two openings 150, 160. The first opening 150 is generally located adjacent to the second end 140 of the generally elongated body 110; while the second opening 160 is generally located midway between the two ends 120, 140. The cross-section of the first and second openings 150, 160 are generally identical and are parallel to the axis at the first end 120. However, it is appreciated that additional openings may be advantageously provided along the generally elongated body 110.

The extension 200 includes a generally elongated body 210, a first end 220 and a second end 230. The first end 220 of extension 200 may be adapted to connect to an input drive of a tire storage winch mechanism. The second end 230 of the extension includes a female adapter member 230 having an axial-spaced internal opening configured and adapted to connect with a male adapter member 330 of the hook driver 300. The extension 200 may be either solid or tubular (i.e., hollow) in construction.

The hook driver 300 includes a generally elongated body 310, a first end 320, and a second end 330. The first end 320 of hook driver 300 includes a hook 350. The hook 350 joins to the body 310 at the first end 320 by a connecting portion 340. The second end 330 of the hook driver 300 preferably includes a male adapter member 330 having an outer diameter slightly smaller than that of the its elongated body 310.

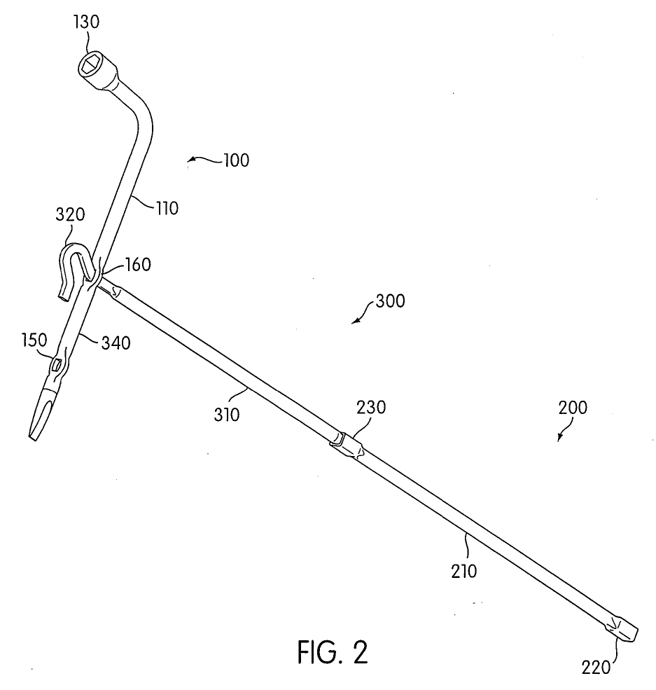

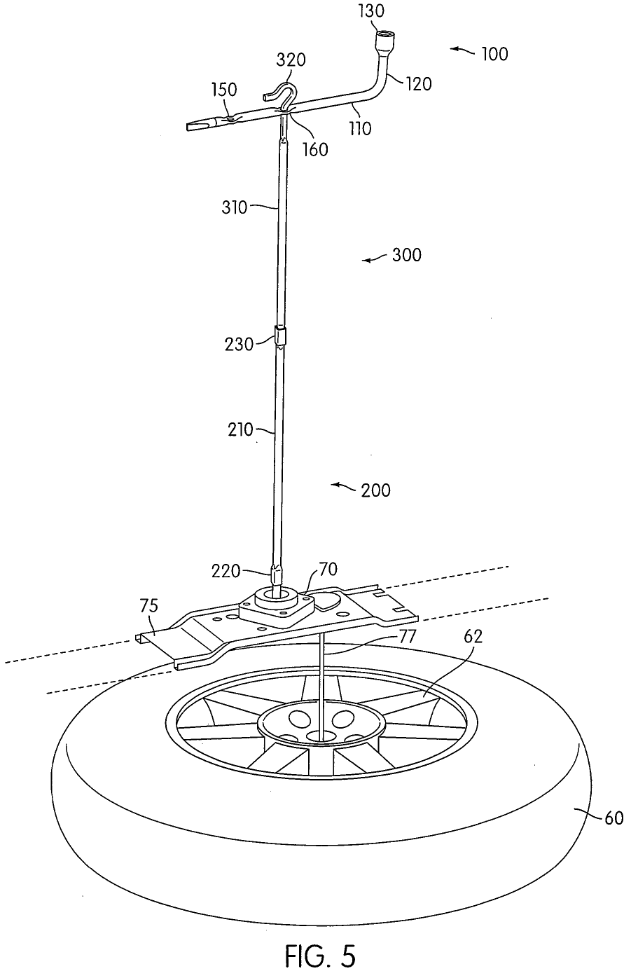

FIG. 2 shows a first configuration utilizing the tool kit 50 of FIG. 1 for actuating a spare tire storage winch mechanism. The extension 200, hook driver 300, and lug wrench 100 are all coupled in the manner as shown in both FIGS. 2 and 5 to activate the spare tire winch mechanism. The male adapter member 330 of the hook driver 300 snugly engages within the corresponding female adapter member 220 of the extension 200. The engagement may be a friction or interference fit and/or include a detent mechanism, for example, as disclosed in U.S. Pat. No. 5,237,890, herein incorporated by reference. The cross section of male adapter member 330 of the hook driver 300 and the female adapter member 220 of the extension 200 may advantageously have a complementary non-circular shape (e.g., square, half circle, triangle, spline, key, etc.) to more effectively transmit torque.

The first end 320 of the hook driver 300 is inserted into one of the first and second openings 150, 160 of the lug wrench 100, such that the connecting portion 340 of the hook driver 300 engages one of the first and second openings 150, 160 of the lug wrench 100. The diameter of the connecting portion 340 of the hook driver 300 is dimensioned to snugly engage by a friction fit or interference fit the first and second openings 150, 160 of the lug wrench 100. Alternatively, the cross section of connecting portion 340 of the hook driver 300 and the first and second opening 150, 160 of the lug wrench may advantageously have a complementary non-circular shape (e.g., square, half circle, triangle, spline, key, etc.) to more effectively transmit torque.

The operator may operatively select one of the first and second openings 150, 160 to provide a particular mechanical advantage, by providing a moment arm, i.e., the distance between the one of the first and second openings 150, 160 and first end 120 of the lug wrench 100. In the embodiment shown in FIGS. 2 and 5, the first end 330 of the hook driver 300 is shown inserted into second opening 160 of the lug wrench.

Ideally, an operator may select the first opening 150 of the lug wrench 100 for the greater mechanical advantage. However, there may be times in which, there may not be sufficient space for the operator to use the greater moment arm, and the operator may select the second opening 160 to shorten the moment arm. This is at the expense of having to exert greater torque to rotate the hook driver 300. While using the second opening 160 has less leverage, it has the advantage that both hands may be applied in a balanced fashion on both sides of the opening.

As shown in FIG. 5, once the three tools 100, 200, 300 are coupled, the operator may grasp the lug wrench 100 and manipulates the hook driver 300 and the extension 200, such that the first end 220 of the extension 200 engages the drive input of a spare tire winch mechanism 70 mounted on a mounting plate 75 of the vehicle (not shown). The winch 70 may be mounted beneath the body and supports the spare tire 60 in a raised position above the ground. The engagement between the first end 210 of the extension 200 and the drive input of the winch 70 may include, but is not necessarily limited to, a tongue and groove, slot, socket, or other rotational coupling means, as known in the art. Accordingly, the first end 210 of the extension 200 may be configured accordingly. A cable 77 connected to the winch 70 engages the wheel 62. The winch 70 raises and lowers the cable 77 which in turn raises and lowers the tire 60.

In this position, the operator may then rotate the lug wrench 100 by grasping and turning the first end 120 of the lug wrench 100, which rotates the extension 200, connected to the winch 70, which thereby raises and lowers the spare tire 60. The lug wrench 100 is at a bent angle with respect to the hook driver 300 and the extension 200, essentially providing the operator with a handle, i.e., the first end 120 of the lug wrench 100.

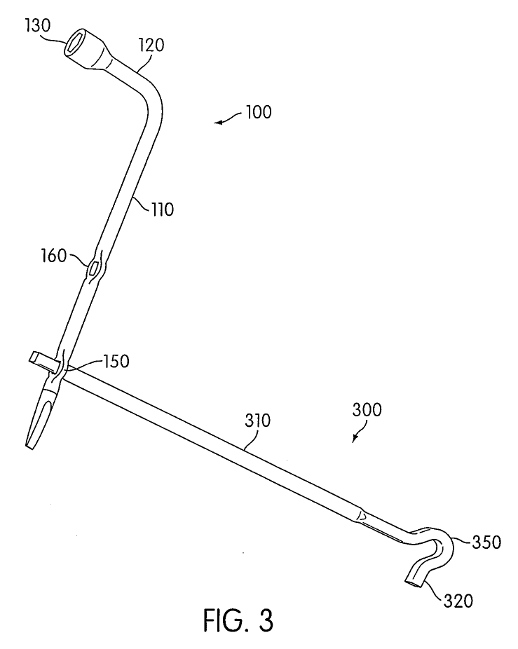

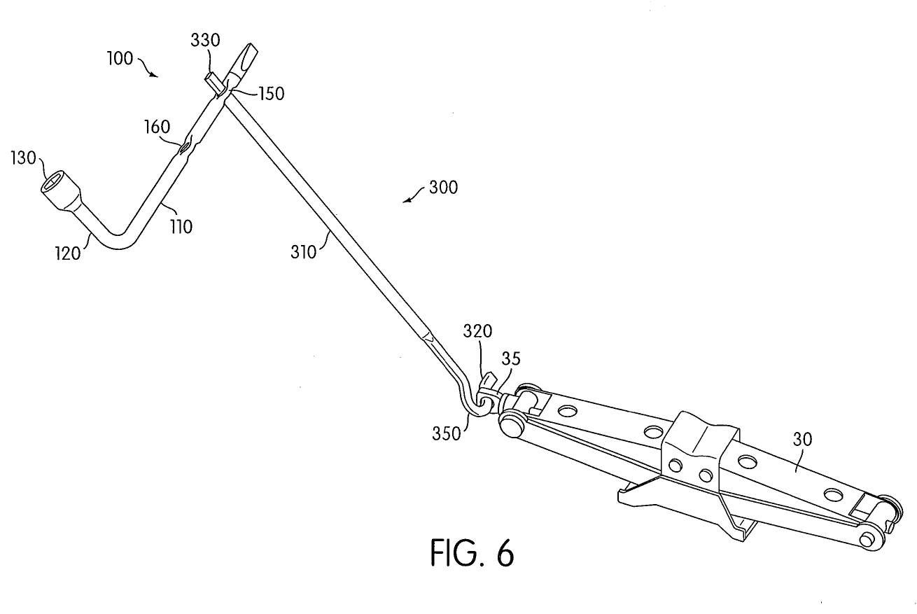

FIG. 3 shows a second configuration utilizing the tool kit 50 of FIG. 1 for actuating a portable vehicle jack. The lug wrench 100 and hook driver 300 are coupled in the manner shown in FIGS. 3 and 6 to act as a jack actuator. The second end 330 of the hook driver 300 is snugly inserted into one of the first and second openings 150, 160 of the lug wrench 100. The operator may operatively select one of the first and second openings 150, 160 of the lug wrench 100 to provide a particular mechanical advantage, by providing a moment arm, i.e., the distance between the one of the first and second openings 150, 160 and the first end 120 of the lug wrench. 100. Alternatively, the cross section of second end 330 of the hook driver 300 and the first and second openings 150, 160 of the lug wrench 100 may advantageously have a complementary non-circular shape (e.g., square, half circle, triangle, spline, key, etc.) to more effectively transmit torque.

In the embodiment shown in FIGS. 3 and 6, the second end 330 of the hook driver 300 is shown inserted into first opening 150 of the lug wrench. Ideally, an operator would select the first opening 150 of the lug wrench 100 for greater mechanical advantage. However, there may be times in which there may not be sufficient space to for the operator to use the greater moment arm, and the operator may select the second opening 160 instead to shorten the moment arm. This is at the expense of having to exert greater torque to rotate the hook driver 300. While using the second opening 160 has less leverage, it has the advantage that both hands may be applied in a balanced fashion on both sides of the opening.

As shown in FIG. 6, the hook 350 of the hook driver 300 may be coupled to a portable vehicle jack 30 by an eye 35 on the input drive of the jack 30. While a scissor jack 30 is shown in FIG. 6, it is understood, that the invention may be practiced with other types of portable jacks for raising and lowering vehicles. In this configuration, the lug wrench 100 is at a right angle with respect to the hook driver 300. The operator may rotate the lug wrench 100 by grasping and rotating the first end 120 of the lug wrench 100, which in turn rotates the hook driver 300 and the input drive of the jack 30 via eye 35 to raise and lower the jack 30. The lug wrench 100 is at a bent angle with respect to the hook driver 300, essentially providing the operator with a handle, i.e., the first end 120 of the lug wrench 100.

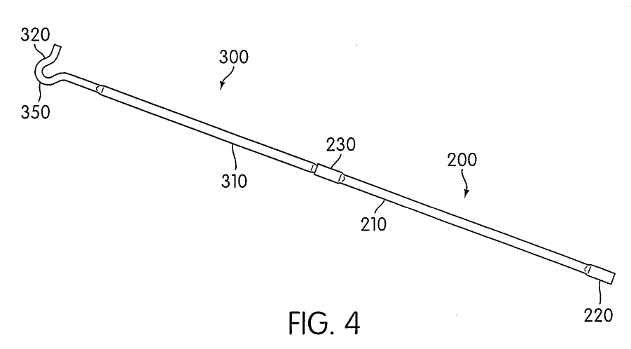

FIG. 4 shows a third configuration utilizing the tool kit 50 of FIG. 1 for a spare tire retrieval operation. The extension 200 and hook driver 300 are coupled in the axial secure engagement shown in FIG. 4 to act as a spare tire retrieval tool. The male adapter member 330 of the hook driver 300 snugly engages within the corresponding female adapter member 220 of the extension 200. The engagement may be a friction or interference fit and/or include a detent mechanism, for example, as disclosed in U.S. Pat. No. 5,237,890, previously mentioned above.

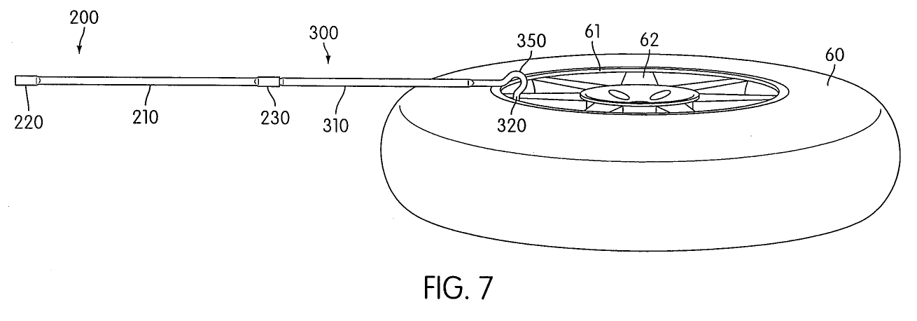

As shown in FIG. 7 the hook 350 of hook driver 300 is used to retrieve a spare tire having been lowered from the vehicle frame to the ground. By grasping the generally elongated body 210 of the extension 200, as a handle, the operator may extend and manipulate the hook driver 300 underneath the vehicle. Further, the hook 350 of the hook driver 300 may be advantageously used to hook onto and grasp a rim 61 of the wheel 62 of the spare tire 60. This configuration effectively extends the grasping reach of the operator and provides an easy way for the operator to retrieve the lowered spare tire 60 on the ground from beneath the vehicle.

The number of tools may be greater than that shown herein. For example, any of the tools may be formed of a number of pieces to shorten the length when disassembled. In one embodiment, the extension 200 may be formed of multiple sections, e.g., two or more sections, which fastened together with a positive lock (snap fit). See, for example, U.S. Pat. No. 5,237,890, mentioned above. Also, the tool kit 50 may be further supplemented with additional tools, e.g., some other tool, having the same features as the lug wrench 100 for engaging the other tools.

The tools 100, 200, 300 of tool kit 50 may be fabricated by known metal working techniques, for example, from a forging of low-carbon steel. Alternatively, the tools 100, 200, 300 may be formed from solid or tubular (i.e., hollow) stock. Further, the tools 100, 200, 300 of tool kit 50 may be suitably hardened and may be subsequently painted or otherwise coated to prevent rusting, to increase operator's grip comfort, and/or to enhance aesthetics.

While the specific embodiments of the present invention have been described above, it will be appreciated that the invention may be practiced otherwise than described. The description is not intended to limit the invention.

What is claimed is:

1. A tool kit to be stored in a vehicle for spare tire retrieval/mounting and operation of a jack for raising and lowering the vehicle, the vehicle comprising a body supported on wheels and a winch mechanism mounted beneath the body and supporting the spare tire in a raised position, comprising:
a lug wrench including a generally elongated body bent at an angle, a first end having a socket, a second end, and at least one opening provided through the body between the second end and the bend;
an extension including a generally elongated body, a first end adapted to be coupled in driving engagement to the drive input of the winch mechanism, and a second end; and
a hook driver including a generally elongated body, a first end having a hook adapted to be coupled in driving engagement to a drive input of the jack, end and a second end, wherein the hook joins to the body at the first end by a connecting portion;
wherein the connecting portion of the hook driver is configured to be coupled in a driving engagement to the at least one opening of the lug wrench, and the second end of the hook driver is configured to be coupled in driving engagement to the second end of the extension to establish a first configuration adapted to activate the winch mechanism for raising and lowering the spare tire from the vehicle frame by coupling the first end of the extension in driving engagement to the drive input of the winch mechanism and turning the lug wrench;
wherein the second end of the hook driver is configured to be coupled in driving engagement to the at least one opening of the lug wrench to establish a second configuration adapted to activate a vehicle jack by coupling the hook of the hook driver in driving engagement to the drive input of the jack and turning the lug wrench;
wherein the second end of the hook driver is configured to be coupled in an axial secure engagement to the second end of the extension to establish a third configuration adapted to grasp and retrieve the spare tire from beneath the vehicle by engaging the hook with the spare tire.

2. The tool kit according to claim 1, wherein the lug wrench includes two openings through the shaft.

3. The tool kit according to claim 1, wherein the bent angle of the lug wrench body is approximately 90 degrees.

4. The tool kit according to claim 1, wherein the second end of the lug wrench includes a blade member.

5. The tool kit according to claim 1, wherein any one of the couplings includes a complementary non-circular shape.

6. The tool kit according to claim 5, wherein the complementary non-circular shape includes one of a square, half circle, triangle, spline and key.

7. The tool kit according to claim 1, any one of the couplings includes a detent mechanism.

8. The tool kit according to claim 1, any one of the couplings include a friction or interference fit.

9. The tool kit according to claim 1, wherein the extension comprises at least two sections.

10. A method for using tooling for spare tire retrieval/mounting, and operation of a jack for raising and lowering the vehicle, the vehicle comprising a body supported on wheels and a winch mechanism mounted beneath the body and supporting the spare tire in a raised position, comprising:
providing a tool kit comprising:
a lug wrench including a generally elongated body bent at an angle, a first end having a socket, a second end, and at least one opening provided through the body between the second end and the bend;
an extension including a generally elongated body, a first end adapted to be coupled in driving engagement to the drive input of the winch mechanism, and a second end; and
a hook driver including a generally elongated body, a first end having a hook adapted to be coupled in driving engagement to a drive input of the jack, end and a second end, wherein the hook joins to the body at the first end by a connecting portion;
wherein the connecting portion of the hook driver is configured to be coupled in a driving engagement to the at least one opening of the lug wrench, and the second end of the hook driver is configured to be coupled in driving engagement to the second end of the extension to establish a first configuration adapted to activate the winch mechanism for raising and lowering the spare tire from the vehicle frame by coupling the first end of the extension in driving engagement to the drive input of the winch mechanism and turning the lug wrench;
wherein the second end of the hook driver is configured to be coupled in driving engagement to the at least one opening of the lug wrench to establish a second configuration adapted to activate a vehicle jack by coupling the hook of the hook driver in driving engagement to the drive input of the jack and turning the lug wrench;
wherein the second end of the hook driver is configured to be coupled in an axial secure engagement to the second end of the extension to establish a third configuration adapted to grasp and retrieve the spare tire from beneath the vehicle by engaging the hook with the spare tire; and
performing in any order:
using the extension, coupled with the hook driver, and further coupled with the lug wrench in the first configuration to rotate the drive input of the winch mechanism to raise and lower the spare tire from beneath the vehicle;
using the hook driver coupled with the lug wrench in the second configuration to rotate the drive input of the jack for raising and lowering the vehicle to allow for mounting of the spare tire; and
using the hook driver coupled with the extension in the third configuration to grasp and retrieve the spare tire lowered from the winch mechanism.

11. The method according to claim 10, further comprising:
using the lug wrench to remove a damaged tire from vehicle; and
using the lug wrench to fasten the spare tire to the vehicle.

12. The method according to claim 10, wherein the lug wrench includes two openings through the shaft.

13. The method according to claim 10, wherein the bent angle of the lug wrench body is approximately 90 degrees.

14. The method according to claim 10, wherein the second end of the lug wrench includes a blade member.

15. The method according to claim 10, wherein any one of the couplings includes a complementary non-circular shape.

16. The method according to claim 15, wherein the complementary non-circular shape includes one of a square, half circle, triangle, spline and key.

17. The method according to claim 10, any one of the couplings includes a detent mechanism.

18. The method according to claim 10, any one of the couplings includes a friction or interference fit.

19. The method according to claim 10, wherein the extension comprises at least two sections.
